(19) United States
(12) Patent Application Publication
(10) Pub. No.: US 2011/0121544 A1
(43) Pub. Date: May 26, 2011

(54) Convertible Trailer

(76) Inventor: Robert Pearce, Victoria (AU)

(21) Appl. No.: 11/720,606

(22) PCT Filed: Dec. 23, 2005
(86) PCT No.: PCT/AU2005/001955

§ 371 Date: Jun. 11, 2010

(30) Foreign Application Priority Data
Dec. 23, 2004 (AU) 2004907334

(51) Int. Cl. B62D 63/06

(52) U.S. Cl. 280/641; 280/639; 280/42

(57) ABSTRACT

A trailer convertible between an in-use configuration and a storage configuration is provide with a fixed draw bar (4) extending to the full length of the trailer. A transverse cross-member (6) being pivotally connected to the drawbar (4). At least two foldable floor panel are mounted onto the drawbar (4). Each floor panel has a side panel fixed to its outside edge The floor panels are folded to an essentially vertical position and the transverse cross-member (6) rotated through about 90° to be aligned substantially parallel with the drawbar (4). A front and rear end panel are replaceably mounted onto the trailer. When converting the trailer from the in-use configuration to the storage configuration, the front and rear end panels are removed. The trailer being provided with wheel assemblies (20) pivotally mounted to the cross-member (6) and being rotatable through 90° when folding the trailer into the storage position.

The present invention relates to load carrying devices in general, and to wheeled load carrying devices in particular. More particularly, the present invention relates to wheeled load carrying devices of the type which are towed by a road-going vehicle, such as for example, a trailer. Even more particularly, the present invention relates to a trailer, such as a domestic trailer and, more particularly, to a trailer, which is convertible between an in-use configuration for transporting a load, and a storage configuration which occupies a minimum of space allowing storage of the trailer in confined areas or the like, particularly in narrow spaces in workshops, garages and the like. The present invention finds particular application as a two wheeled trailer which can be folded conveniently and swivelled so as to occupy, when in a storage configuration, a width which is only slightly greater than or less than the width of one of the road going wheel assemblies of the trailer. The convertibility of the trailer of the present invention is primarily achieved by having a transverse member pivotally mounted to a longitudinal member in which the transverse member also carries a wheel assembly at either end which wheel assemblies may be pivotable with respect to the transverse member, so that the wheel assemblies can align along the lengthwise extending direction of the longitudinal member in order for the trailer to occupy a minimum width when in the storage configuration. Additionally, the trailer can have a number of different forms in which the sides and/or ends of the trailer are foldable or are removable including combinations of foldable and removable ends and/or sides.

Although the present invention will be described with particular reference to one form of a convertible trailer, it is to be noted that the scope of the present invention is not limited to trailers but rather, the scope of the present invention is broader so as to include other forms and arrangements of any load carrying device or similar devices, such as for example, foldable pallets, crates, containers and other transportation devices which are convertible between two different configurations as well as other means of operation of the load carrying device, including other means for converting the load carrying device between the storage configuration and the in-use configuration, and the use of such arrangements in applications other than as a trailer.

In the past, trailers towed behind motor vehicles have been used to carry loads. Although trailers are available in a wide variety of different styles and types, the trailers used domestically suffer from a number of shortcomings.

Trailers designed to be towed behind vehicles and used for transporting various items or loads, often in domestic situations, present the owner with a storage problem when the trailer is not being used. Attempts have been made to solve this problem by designing various mechanisms to reduce the size of trailers when being stored. Most of the previously available trailers purporting to having space saving capabilities have been costly to construct and/or cumbersome or difficult to prepare for storage and/or for usage and/or to convert between the storage configuration and use configuration; some necessitate the lifting of heavy components to enable the operator to complete the conversion process between storage and use configurations; some require the wheel-assemblies to be moved in a direction that is not in accordance with the normal or usual direction of rotation of the wheels about their axles, thereby requiring the tires to be skidded across the ground or lifted clear of the ground whilst being moved to or from the folded and/or unfolded positions. Some trailers compress into a format which does not provide any significant benefit in accommodating the trailer in a storage position since the width of the trailer in this position is not significantly less than the width of the trailer when in the normal in-use configuration.

The length and the height of a trailer to be stored, when in the normal use position or when in a storage configuration, are frequently not as limiting on the storage capability of the trailer as is the width, such as for example, if the trailer is to be stored alongside the vehicle used to tow it. Thus, the trailer can be long and high as well as it is not broad. Thus, there is a need for a trailer which has a minimum width when being stored or when in a storage configuration, which is easy to convert between the in-use configuration and the storage configuration and which is of a size capable of carrying a reasonable load in the use configuration. Further, there is a need for a trailer that can be converted between the different modes by a single person only or single handedly.

It is to be noted that not all forms of the present invention satisfy all aims or objects, rather some forms may satisfy one aim whilst other forms satisfy other objectives.

According to another aspect of the present invention, there is provided a load carrying device convertible between a first configuration, which is an in-use configuration, and a second configuration, which is a storage configuration, in which the load carrying device, when in the storage configuration, occupies a reduced amount of space when compared to the space required for the in use configuration, and wherein the load carry device comprises support elements for supporting the load carrying device, said support elements being located in different orientations with respect to each other.

According to one aspect of the present invention, there is provided a load carrying device convertible between an in-use configuration for carrying a load and a storage configuration, said load carrying device, when in the storage configuration, having a reduced size at least in one dimension than when in the in-use configuration, comprising a first member and a second member being pivotable with respect to each other arranged so that when the carrying device is in the in-use configuration the two members are transversely arranged and when the load carrying device is in the storage position, the two members are substantially aligned with each other to extend in a common direction.

Typically, the first member is a main support member. More typically, a fixed main support member that extends longitudinally along the lengthwise extending axis of the load carrying device. More typically, the first member is a draw bar.

Typically, the second member is a secondary support member. More typically, the second member is pivotally connected to the main support member. Even more typically, the second support member is substantially perpendicular to the main support member when in the in-use configuration and is substantially parallel to the main member in the storage configuration. More typically, the second member is a movable cross-bar.

Typically, the load carrying device is a trailer, caravan, or similar vehicle capable of being towed, typically a two wheeled trailer, more typically, a two wheeled domestic trailer of the type towed by a motor vehicle by a home owner or similar.

Typically, the trailer is provided with a load supporting structure. More typically, the load supporting structure includes at least one foldable panel, preferably two or more foldable panels. More typically, the panels are folded in a generally vertical direction either upwardly or downwardly or a combination of both.

Typically, the trailer is provided with sides and ends, typically in the form of panels. The panels may be foldable or removable. If foldable, the panels can be folded up or folded down. More typically, the side and/or end panels are provided with releasably securable fasteners allowing quick and/or easy removal of the panels.

Typically, the trailer is provided with one or more wheel assemblies. More typically, the wheel assemblies are moveably mounted to the trailer, particularly to the cross-member. Even more typically, the wheel assemblies include at least one road wheel. Even more typically, the road wheel is pivotal so as to adopt at least two configurations with respect to the cross-member or transverse member.

Typically, the reduced size in at least one dimension is the width of the trailer so that the trailer in the in-use position is much wider than the width of the trailer in the storage position. However, it is to be noted that the trailer may also have a smaller height in some embodiments and/or a smaller length in other embodiments or the height and/or length may be increased when the trailer is in the storage configuration such as for example, to take into account the reduction in width.

Typically, the trailer of the present invention is provided with a stand. More typically, the stand is capable of adopting at least two positions, one position associated with the trailer when in the in-use configuration and another position associated with the storage position or the process of converting the trailer between the storage configuration and the in-use configuration.

More typically, the stands can be separate to the trailer since the stands are only used to convert the trailer between the two positions. In this case, the stands can be stored at the same location as the trailer since they are only needed to convert the trailer and are not needed for the trailer when in use.

In one form, the present invention is an improved folding trailer that can, quickly and easily, be folded for storage or unfolded for use. More typically, the trailer is a trailer of cost-effective construction using simple design and readily available components and materials assembled in a unique manner to allow the trailer to be folded into a reduced size for storage, particularly a reduced width for storage. The folding and unfolding operations are facilitated by the fact that there is a pivoting action of the cross-member with respect to the longitudinal drawbar as well as the pivoting action of the wheel-mounted cross-member or transverse member under the cross-member or drawbar is assisted by the wheels rotating on their axles during the process as well as pivoting, thereby eliminating the need to drag or skid the tires over the floor surface or substrate upon which the trailer rests or to unnecessarily lift the trailer off the floor or substrate to convert the trailer from one configuration to the other configuration. It is to be noted that some lifting of the trailer off the floor may be required for some embodiments of the trailer

A convenient format for storage of the trailer when in the storage condition is provided by the wheel-mounts or wheel assemblies or suspension system containing the road wheels individually pivoting under the cross-member to align the wheels with the longitudinally extending drawbar, i.e., along the direction of the drawbar of the folded trailer, thereby reducing the width of the folded trailer significantly, typically to a width which is about the same width as or slightly more or less than the width of one wheel or of one wheel assembly of the trailer such as for example, when the diameter of the road wheel is about 400 mm, the trailer can be folded to a width of about 500 mm. When unfolded and in-use, the trailer is relatively light in weight, stable and sturdy, and provides a useful capacity for transporting various items or loads.

In one form, the trailer according to the present invention provides a convenient means of transporting items or loads, and a simple, practical procedure of folding to provide a useable storage format. As the improved folding trailer is primarily intended for use in a domestic situation where it is to be drawn by a motor vehicle, such as the family car, it is designed with a strong emphasis on cost-effectiveness of construction to provide a relatively low cost trailer that is useful and has benefits for the user, owner or householder without disproportionate cost to the owner.

Preferably, the trailer has a drawbar which extends either part of the full length of the trailer in a longitudinal direction which is referred to as the longitudinal axis of the trailer. As an example, the drawbar can extend to about ¾ the length of the trailer. Two foldable floor-panels are affixed longitudinally with hinges, one on each side of the drawbar. Each floor-panel has a side panel fixed to its outside edge by suitable fasteners such as hinges similar to the hinges connecting the floor panels. In one embodiment, the side panel is folded with respect to the floor panel, or mounting fitting or the like. In other embodiments, the side panels are replaceably removable from the floor using suitable fittings for mounting the side panels. Preferably, the side panels can be folded upwardly and over the floor panels to overlie the floor panels during conversion from one configuration of the trailer to the other configuration. Additionally, a removable front-panel is attached to the front edge of the floor-panels with detachable hinge fittings and held vertically in place with locking devices attached to the front edge of the side panels. A removable rear panel is similarly replaceably attached to the rear of the trailer. A cross-member is pivotally fixed to the underside of the drawbar and held in position by suitable positioning devices at each end which connect with the underside of the floor-panels. Wheel-mounts are either pivotally connected at or towards both ends of the cross-member which are similarly held in position by suitable positioning devices or the wheel mounts are fixed to the cross-member so that the road wheels can rotate but not pivot with respect to the cross-member.

### BRIEF DESCRIPTION OF THE DRAWINGS

The present invention will now be described by way of non limited examples with reference to the accompanying drawings in which:

FIG. 1 is a front perspective view illustrating one form of the trailer of the present invention when unfolded, assembled and prepared for use in the in-use configuration;

FIG. 2 is a side elevation view of the trailer of FIG. 1;

FIG. 3 is a rear elevation view of the trailer of FIG. 1;

FIG. 4 is a rear elevation view of the trailer of FIG. 1 part way through conversion from the in-use configuration to the storage configuration with the front-end panel and the rear-end panel removed but with the floor-panels and side-panels unfolded remaining in the in-use configuration;

FIG. 5 is a rear elevation view of the trailer of FIG. 1 in a partially folded configuration further through the conversion from the in-use configuration to the storage configuration with one side-panel folded to overlie the respective floor-panel and the other side-panel remaining in the in-use configuration extending substantially vertically from the other side floor-panel;

FIG. 6 is a rear elevation view of the trailer of FIG. 1 further through the conversion process with both side-panels folded to overlie the respective floor-panels;

FIG. 7 is a rear elevation view of the trailer of FIG. 1 further through the conversion process with one combined floor-panel/side-panel folded to a vertical position whilst the other floor panel/side panel remains in a horizontal position;

FIG. 8 is a rear elevation view of the trailer of FIG. 1 still further through the conversion process with both combined floor-panels/side-panels folded to a substantially vertical position;

FIG. 9 is a rear elevation view of the trailer of FIG. 1 still further through the conversation process showing the cross-member aligned along the lengthwise extending axis of the longitudinal drawbar and road wheel in the transverse position to the cross-member;

FIG. 10 is a rear elevation view of the trailer of FIG. 1 in the storage configuration showing the road wheel in longitudinal alignment with the drawbar and cross-member;

FIG. 11 is a side elevation view of the trailer as shown in FIG. 10 in the stored configuration with both wheels aligned along the drawbar of the trailer;

FIG. 12 is a rear elevation view of an alternative embodiment of the trailer showing the sides and ends completely removed from the trailer and the floor panels remaining in the in-use configuration.

FIG. 13 is a rear-elevation view of the alternative embodiment of the trailer shown in FIG. 12 part way through the conversion process with both the floor panels folded upwardly to a substantially vertical position.

FIG. 14 is a rear elevation view of the alternative form of the trailer shown in FIGS. 12 and 13 further through the conversion process showing the cross member aligned along the lengthwise extending axis of the longitudinal drawbar and the road wheel in a transverse position to the cross-member.

FIG. 15 is a rear elevation view of the alternative form of the trailer of FIGS. 12 to 14 in the storage configuration with the road wheel in longitudinal alignment with the drawbar and cross-member.

FIG. 16 is a rear elevation view of another alternative embodiment of the trailer showing the sides and ends completely removed from the trailer and with the floor panels remaining in the in-use configuration.

FIG. 17 is a rear-elevation view of the alternative embodiment of the trailer shown in FIG. 16 part way through the conversion process with both the side floor-panels upwardly folded with respect to the central floor panel and a support stand affixed into a stabilizing position to assist in the conversion.

FIG. 18 is a rear elevation view of the alternative form of the trailer shown in FIGS. 16 and 17 further through the conversion process showing the cross member aligned along the lengthwise extending axis of the longitudinal drawbar and the road wheel in a transverse position to the cross-member.

FIG. 19 is a rear elevation view of the alternative form of the trailer of FIGS. 16 to 18 in the storage configuration showing both the side floor-panels downwardly folded.

FIG. 20a is a front view and FIG. 20b is a side elevation view of the suspension system of one form of the trailer for mounting the road wheel to the cross-member.

FIG. 21 is a front view of an alternative form of the suspension system for mounting the wheel to the cross-member of the trailer.

FIG. 22a is a front elevation view and FIG. 22b is a side elevation view of a still further embodiment of the suspension system for mounting the wheel to the cross-member.

FIG. 23a is a front elevation view and FIG. 23b is a side elevation view showing a still further alternative form of the suspension system for mounting the road wheel to the cross-member.

FIG. 24 is a rear elevation view of another form of the trailer of the present invention showing a still further alternative suspension arrangement for mounting the road wheels to the cross-member.

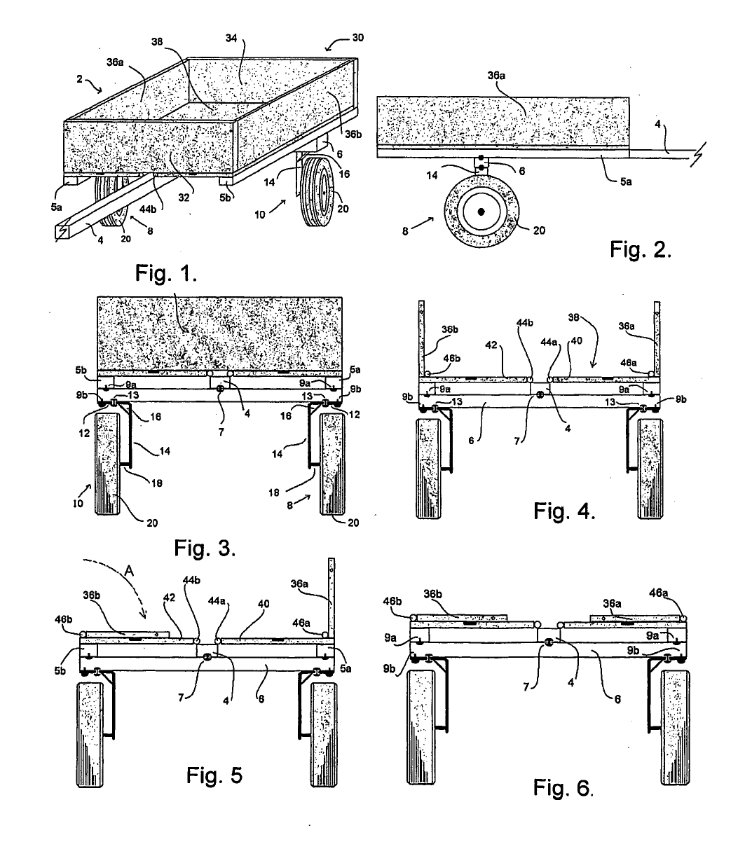

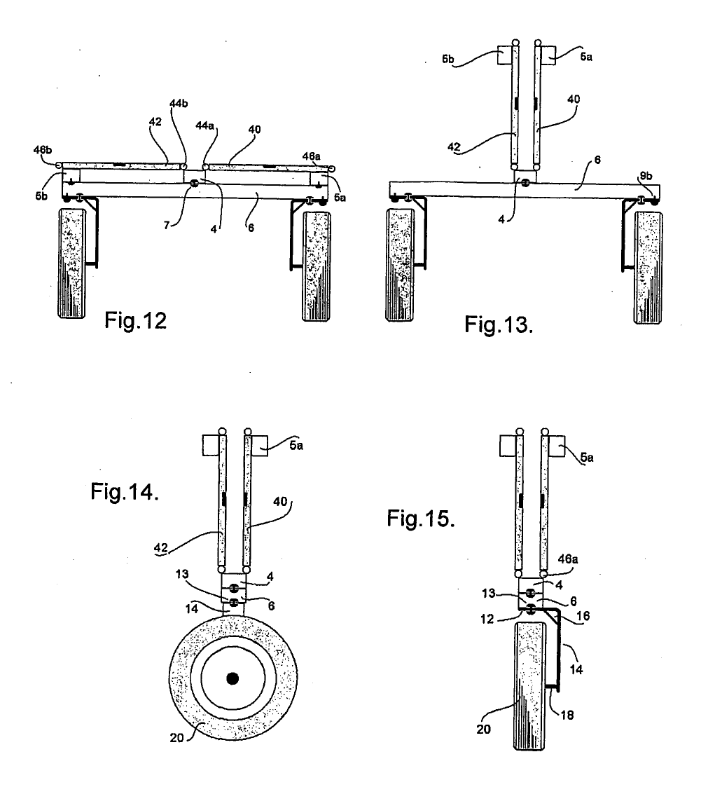

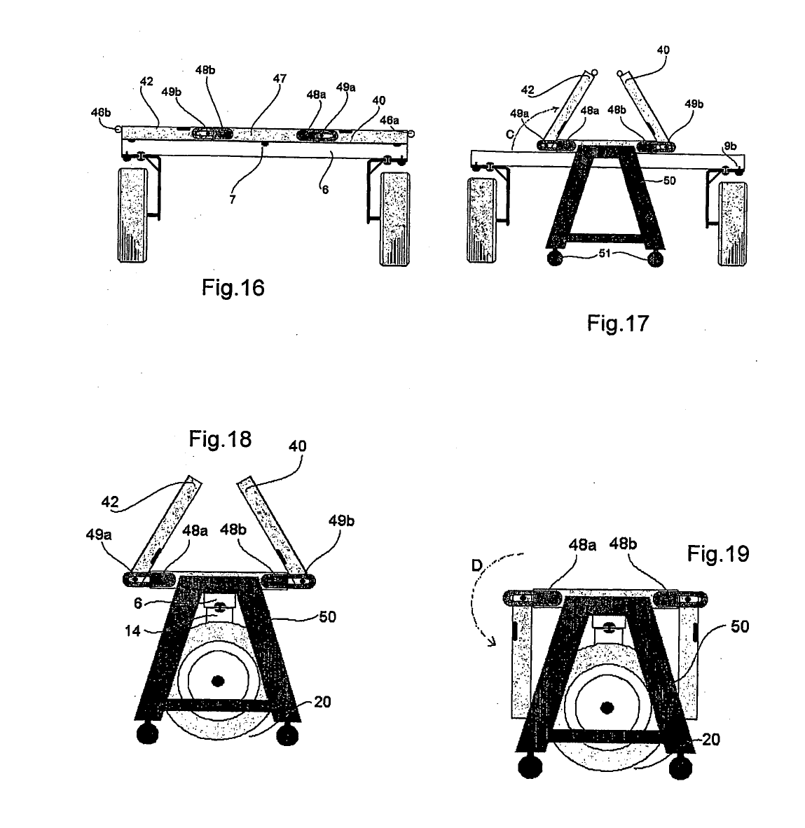

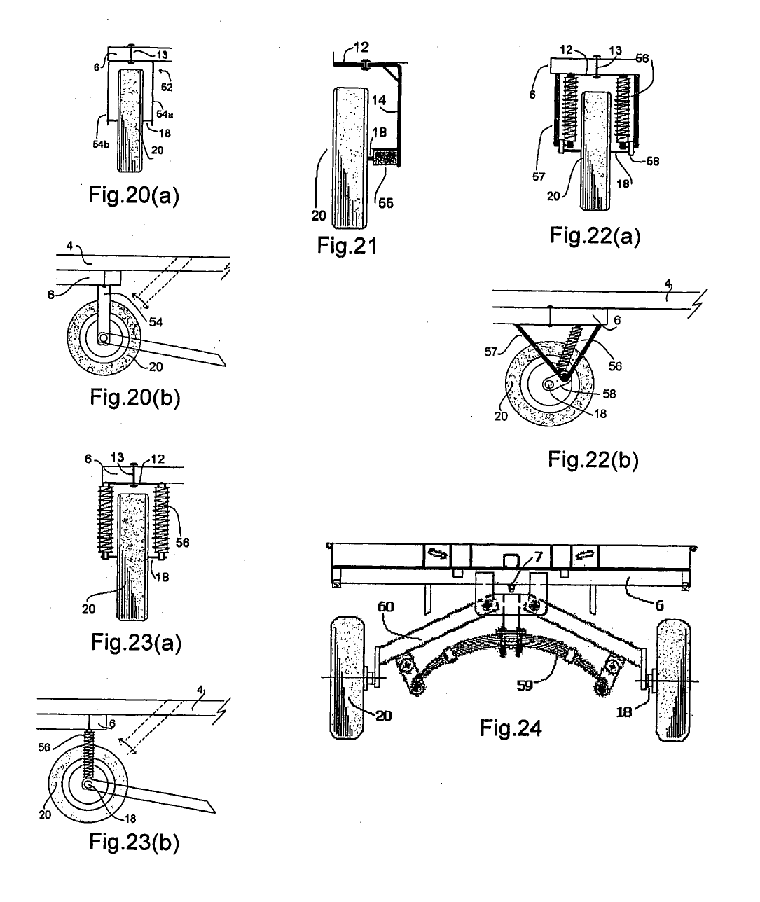

In the drawings, there are shown a number of different embodiments of the trailer of the present invention. The different embodiments will now be described in detail in turn. The same reference numerals are used to identify the same or corresponding features of the different embodiments of the trailers. One embodiment is shown in FIGS. 1 to 11 whereas another embodiment is shown in FIGS. 12 to 15 and another in FIGS. 16 to 19. Different forms of the suspension arrangement of the trailer are shown in FIGS. 20 to 24.

With particular reference to FIGS. 1 to 11, one form of the trailer, which is generally denoted as 2, comprises a longitudinally extending fixed drawbar 4 provided with a towing hitch (not shown) or similar towing means located at or towards one end, which for ease of reference and clarity of understanding, will be referred to as the forward end of the trailer which faces towards the rear of the towing vehicle. However, it is to be noted that use of terms such as rear, forward, side, vertical, horizontal and the like, are merely for clarity of expression and ease of understanding and are not meant to be limiting to the scope of the present invention in any way unless the contrary meaning is intended.

Further, it is to be noted that any suitable towing hitch or similar, such as a towing ball and socket arrangement, may be used with the trailer of the present invention.

A pair of spaced apart substantially parallel longitudinally extending side rail members 5a, 5b are located on either side of trailer 2 in parallel relationship to each other and to draw bar 4. In other embodiments, a suitable supporting framework (not shown) is provided, such as for example, a rectangular or square framework consisting of two or more longitudinal members corresponding to members 5a, 5b and two or more transverse members interconnected together to form a generally rectangular frame. In this embodiment, the framework members or the frame itself is foldable together with the foldable panels to be described in more detail later in this specification in order for the trailer to be able to be converted between the storage configuration and the in-use configuration.

A transverse cross-member 6 is pivotally connected to longitudinal drawbar 4 for pivoting movement thereabout through about 90° to the longitudinal member. In the in-use configuration, transverse cross-member 6 is arranged to extend perpendicularly to longitudinal draw bar 4 as shown in FIGS. 1 to 8. A suitable pivoting fastener 7 is used to connect drawbar 4 to cross-member 6 to allow the pivoting movement. A suitable locking arrangement in the form of a releasably securable pin 9a or similar is provided to lock cross-member 6 with respect to longitudinal members 5a,b in the perpendicular position when in the in-use configuration so as to prevent unwanted rotation of cross-member 6 in-use of trailer 2 and/or to maintain the trailer in the in-use configuration. One pin 9a is provided on either side of cross-member 6 for cooperatively engaging with respective ones of longitudinal members 5 to securely anchor cross-member 6 so as to prevent unwanted rotation with respect to drawbar 4 when the trailer is in the in-use configuration.

A first wheel assembly 8 is located at or towards one side of trailer 2 connected to one end of transverse member 6. Wheel assembly 8 depends downwardly from the under surface of cross-member member 6 and in one form is connected thereto by the use of a generally L-shaped bracket having an upper plate 12, which is pivotally fastened to the under surface of one end of cross-member 6, by a suitable fastener 13 which allows pivoting movement of the wheel assembly 8, a downwardly depending arm 14 extending substantially perpendicular to the plane of plate 12 and connected thereto by strut 16 or gusset for increased strength. Axle 18, such as a stub axle or similar, extends outwardly from the lower end of arm 14. Road wheel 20 is journalled for rotation about axle 18 in accordance with movement of trailer 2. Road wheel 20 may take any suitable or convenient form including any tire and rim combination. One of pins 9b is used to lock wheel assembly 8 in place so as to maintain wheel 20 in the desired position allowing trailer 2 to be towed when in the in-use configuration as shown in FIG. 1.

It is to be noted that other forms of connecting wheel assembly 8 to cross-member 6 are possible, such as for example, the embodiments shown in FIGS. 20 to 24. As an example, the embodiment in FIG. 20 includes a generally rectangular V-shaped bracket or yoke arrangement 52 having a pair of opposed arms 54a, 54b on either side of the bracket arranged to extend on either side of road wheel 20 such that the respective distal ends of arms 54a, 54b are interconnected by axle 18 carrying road wheel 20. Other embodiments will be described in detail later.

Another wheel assembly 10, similar or the same as the previously described wheel assembly 8, is located on the opposite side of cross-member 6 and includes the same features or components identified by the same reference numerals as wheel assembly 8. Trailer 2 is supported upon the two wheel assemblies 8, 10 which include road wheels 20 that are free to rotate independently of each other in operation of trailer 2, such as when being towed behind a vehicle, and when trailer 2 is being converted between an in-use configuration and a storage configuration, and when trailer 2 in the stored condition or configuration is being manually maneuvered into its final storage or resting position since road wheels 20 support the trailer.

It is to be noted that in some embodiments of the trailer, there can be two axles 18, each connected to a road wheel at either side of the trailer in the in-use configuration or there can be a single axle interconnecting the two road wheels in which the axle is pivotally connected to the cross-member to assist in folding the trailer into the storage configuration.

One form of the load carrying subassembly of trailer 2 will now be described.

Load carrying assembly 30 includes front end-panel 32, rear end-panel 34 and side-panels 36a, b. Front, rear and side-panels 32, 34 and 36a, b may take any suitable or convenient form or may be of any suitable or convenient length, width and thickness. Additionally, the panels may be made from any suitable material.

The load carrying assembly includes trailer floor 38. Front end panel 32 is releasably securable to floor 38 of trailer 2 by suitable releasably securable fastening means allowing the panel to be removed and reinstated quickly and easily. Any suitable form of fastener can be used. Additionally, rear-end panel 34 is releasably securable to floor 38 by suitable fasteners similar to those used for connecting the front-panel to the floor 38. In one embodiment, front and rear end-panels 32, 34 are completely removable from the remainder of trailer 2, whereas in other embodiments (not shown) the panels are foldable by being hinged to other parts of the trailer.

Floor 38 of load assembly 30 will now be described. Floor 38 comprises two panels 40, 42 which when the trailer is in the in-use configuration are arranged in side by side relationship to each other in a common horizontal plane particularly as shown in FIGS. 3 to 6. Each panel 40, 42 is hingedly connected to either side of drawbar 4 respectively for respective rotational movement or hinged movement thereabout. Hinges 44a, b are located along the inboard longitudinally extending edge of panels 40, 42 respectively and the top of outwardly facing edges of drawbar 4. In other embodiments, hinges 44a, b may be located along the top surface of drawbar 4, along the top edge or corner of drawbar 4 or at or along the outwardly facing side surfaces of drawbar 4 depending upon whether the panels 40, 42 fold up or fold down.

Side-panel 36a is hingedly connected to the outer longitudinally extending edge of panel 40 by hinge 46a, whereas side-panel 36b is hingedly connected to the outer longitudinally extending edge of panel 42 by hinge 46b. Side-panel 36a is hingedly foldable against floor-panel 40 so as to at least partially overlie floor-panel 40, whereas side-panel 36b is hingedly foldable with respect to floor-panel 42 in the direction of arrow A of FIG. 5 so as to at least partially overlie floor-panel 42 when in a folded configuration, as shown more particularly in FIG. 6.

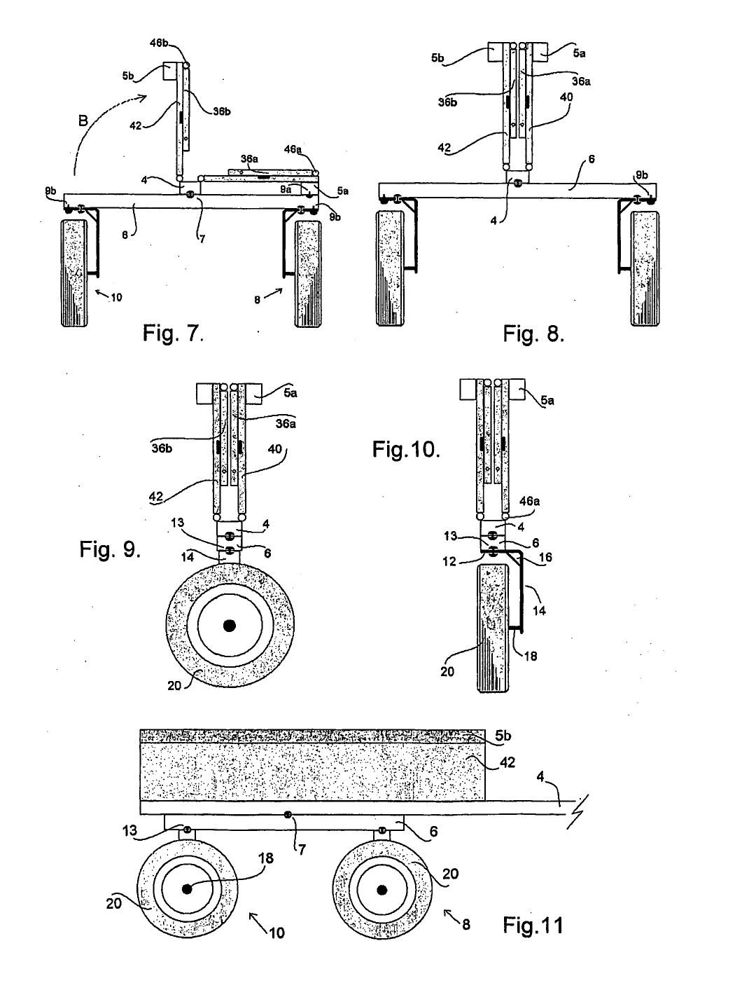

Combined floor-panel 40 and side-panel 36a are hingedly foldable as a single unit with respect to central drawbar 4 about hinge 44a to adopt an upwardly extending substantially vertical configuration as shown in FIG. 8. Similarly, combined floor-panel 42 and side-panel 36b, when in folded configuration, are hingedly rotatable about hinge 44b as a single unit in the direction of arrow B to adopt a generally upstanding substantially vertical configuration as shown in FIGS. 7 and 8. Thus, the floor of assembly 30 is convertible from being substantially horizontal to being substantially vertical by being hinged to central drawbar 4, as shown in FIG. 8.

In operation of the present invention, when it is desired to convert trailer 2 from an in-use configuration, as shown in FIGS. 1 and 2, to a storage configuration as shown in FIGS. 10 and 11, the following sequences of operations are carried out.

Firstly, trailer 2, when in an empty condition, can be optionally removed from the towing vehicle and optionally is placed on a suitable support stand or similar (not shown), or optionally may remain attached to the towing apparatus of the vehicle until part way through the various steps of forming the sequence of converting the trailer from the in-use position to the storage position to assist in maintaining the trailer 2 in a stable condition. Front end-panel 32 is removed from floor-panels 40, 42 by disconnecting the fasteners connecting this panel to both floor-panels. Similarly, rear-panel 34 is removed from trailer 2 by disengaging from floor-panels 40, 42. Both front end-panel 32, and rear end panel 34 can be stored in a convenient location or can be reattached to the trailer when in the storage configuration and/or in the final stored position within the workshop, garage or similar. It is to be noted that in some embodiments, end panels 32, 34 are hingedly connected to the trailer and/or the side panels so that they can be folded into position rather than being removed from the trailer.

Side-panel 36a is folded from a vertical position as shown in FIG. 4 to a horizontal position as shown in FIG. 6 so as to be folded flat against the upper surface of floor panel 40 as shown in FIG. 6, whereas side-panel 36b is folded from a vertical position as shown in FIG. 4 in the direction of arrow A to a horizontal position as shown in FIGS. 5 and 6 so as to be folded flat against the upper surface of floor panel 42, to adopt a configuration as shown particularly in FIGS. 5 and 6. In this position, the load carrying assembly is in a substantially flat configuration as shown in FIG. 6, with both side wall-panels 36a, b and floor-panels 40, 42 substantially horizontal, resting between the central drawbar 4 at their respective inboard edges and the pair of longitudinal members 5a, 5b at their respective outboard edges, which in turn rest upon cross-member 6 which is supported by road assemblies 8, 10.

Releasable securing pins 9a are then removed or released allowing longitudinal members 5a, 5b to be released from cross-member 6 and thus be able to move relative to cross-member 6.

Side wall 36a and floor-panel 40 together with longitudinal member 5a are then rotated as a single unit about hinge 44a, from a horizontal position as shown in FIG. 7 to assume a substantially vertical orientation as shown in FIG. 8, and side wall-panel 36b and floor-panel 42 together with longitudinal member 5b as a single unit are rotated about hinge 44b in the direction of arrow B from the substantially horizontal position as shown in FIG. 6 to a substantially vertical position, as shown in FIGS. 7 and 8.

As pins 9a have been removed or released previously, cross-member 6 which is pivotally connected to central drawbar 4 is able to be pivotally rotated in a horizontal plane about drawbar 4 from a substantially transverse position, as shown in FIGS. 1 to 8, to a substantially aligned position, in which cross-member 6 is aligned longitudinally along the lengthwise extending direction of drawbar 4, as shown particularly in FIGS. 9 to 11. If desired, cross-member 6 can be locked to drawbar 4 in this storage position by using pins 9a if desired to maintain drawbar 4 and cross-member 6 in substantially parallel relationship to one another.

As wheel assemblies 8 and 10 are each pivotally connected to the underside of either end of cross-member 6, when both wheel assemblies are unlocked from cross-member 6, such as by releasing respective pins 9b from cross-member 6, wheel assemblies 8, 10 are each rotated about respective fasteners 13 through about 90° from a position in which road wheel 20 is substantially transverse to cross-member 6, as shown in FIG. 9, to a position in which road wheel 20 is substantially aligned along the lengthwise extending direction of cross-member 6, as shown in FIG. 10, i.e. in this new position wheel 20 is parallel to cross-member 6.

In this fully folded configuration or storage configuration, trailer 2 is arranged with one wheel assembly 8 mounted in front of the other wheel assembly 10, both with their respective road wheels 20 substantially aligned along the lengthwise extending direction of drawbar 4, as shown in FIGS. 10 and 11. This is the storage position of trailer 2 which allows trailer 2 to be conveniently stored in a small space, since the width of the trailer in the stored configuration is only substantially wider than the L-shaped bracket 14 of the wheel assemblies 8, 10, which is slightly greater than about the width of road wheel 20 and axle 18 as shown in FIG. 10.

The length of trailer 2 in the stored configuration is no greater than about the length of trailer 2 when in the towing configuration, since the length of cross-member 6 is less than the length of drawbar 4 and of the load carrying assembly 30, as shown more particularly in FIG. 11.

When in the stored configuration, the trailer may be conveniently stored against the wall of a garage, workshop, shed or similar, or may be inserted into a narrow width at a convenient location.

As the road wheels 20 of each wheel assembly 8, 10 are each free to rotate about respective axles 18 at will, when the cross-member 6 pivots with respect to drawbar 4, wheels 20 merely rotate in opposite directions to each other about their respective axles 18 allowing the trailer to be rolled and are not dragged or skidded across the substrate upon which the trailer is located, such as the floor of a workshop, garage or similar. Furthermore, as the wheel assemblies 8, 10 are each pivotally connected to cross-member 6 by fasteners 13, the wheel assemblies 8,10 can be readily rotated or pivoted about fastener 13 through 90° from a transverse orientation to a longitudinal orientation merely by pivoting about the part of the tire in contact with the ground or floor, and accordingly the wheels 20 are not dragged or skidded.

Furthermore, when trailer 2 is in the stored configuration, as shown in FIGS. 10 and 11, trailer 2 may be wheeled on both road wheels 20 from one location to another until a convenient storage position is located, or until the trailer is safely located in its final resting or stored position, since road wheels 20 are free to rotate and to support the weight of load assembly 30.

Further, it is to be noted that in the embodiment of FIGS. 1 to 11, at all times trailer 2, irrespective of which stage it is in the conversion between the use position and the stored position, always rests on wheel assemblies 8,10 including road wheels 20 and always can be readily moved on these wheel assemblies. However, in other embodiments the trailer may rest on stands, stabilizers, outriggers or the like.

When it is desired to convert the trailer from the storage configuration to the in-use configuration, the reverse procedure to that described above is used.

Other embodiments of the trailer of the present invention will now be described. In FIGS. 12 to 15 is shown an alternative embodiment of the trailer of the present invention. In this embodiment the front panel 32 and the rear panel 34 are arranged substantially the same as the front and rear panels 32, 34 of the embodiment shown in FIGS. 1 to 11 allowing complete removal of each of the front and rear panels from the remainder of the trailer using suitable releasably securable fittings. In this alternative embodiment the side panels which are referred to as side panels 36a, 36b in the embodiment of FIGS. 1 to 11, particularly FIG. 4 are also completely removable from the trailer so that the sides need not be folded but rather can be removed from the trailer entirely using suitable releasable securing fittings allowing replaceable detachment of the side panels. In this embodiment suitable fasteners allowing the sides to be removed from the trailer are provided. Any suitable fastener can be employed including using hinges or the like. It is to be noted that reference numerals 46a, 46b of FIG. 12 refer to hinges or to other suitable fasteners allowing the sides to be replaceably secured to the trailer and/or to be folded.

In the embodiment shown in FIGS. 12 to 15 when the front panel, rear panel and two side panels are removed from the trailer the two floor panels 40, 42 can be folded from a substantially horizontal position as shown in FIG. 12 to a substantially vertical position as shown in FIG. 13 in a manner similar to the previously described embodiment. Longitudinal members 5a, 5b are also folded when floor panels 40, 42 are folded. The trailer having the removable sides is convertible between the in-use configuration and the storage configuration in the same manner as the trailer of FIGS. 1 to 11 is convertible between the two configurations.

In the embodiment of FIGS. 12 to 15, the floor panels 40, 42 are maintained in the vertical plane or position using a suitable means such as a holding means (not shown). Examples of holding means include a bridging plate or torsion springs on the hinges or similar.

In FIGS. 16 to 19 is shown another alternative embodiment of the trailer of the present invention. Again the front panel 32, the rear panel 34 and the side panels 36a and 36b as shown in FIG. 1 are completely removable from the trailer so that the sides need not be folded but rather can be removed from the trailer entirely using suitable releasably securable fittings allowing replaceable detachment of the panels. Any suitable fittings can be employed including hinges. It is to be noted that as with FIG. 12, reference numerals 46a, 46b refer to hinges and/or other suitable fasteners allowing the sides to be replaceably secured to the trailer.

In the embodiment of FIGS. 16 to 19, the trailer has a central floor-panel 47 in addition to the two side floor panels 40, 42 in which the two side floor-panels 40, 42 are affixed longitudinally with hinges, one on each side of the central floor-panel 47. Alternatively side floor-panels 40, 42 can be hinged to the central floor-panel 47 by the use of hinge plates 48a and 48b fixed to or otherwise incorporated into the rear end of central floor-panel 47 and similar fittings to hinge plates 48a, 48b fixed to or otherwise incorporated into the front end of central floor-panel 47 so that there is a pair of hinges at each end of the trailer. The hinge plates 48a, 48b are structured with slots within which hinge pins 49a and 49b are able to move axially in such a way so as, in conjunction with similar fittings at the front end of central floor-panel 47, to allow side floor-panels 40, 42 to be laterally pivoted in an upward or downward direction from their substantially horizontal position without being obstructed by the side edges of central floor panel 47.

In one embodiment, when the front panel, rear panel and two side panels are removed from the trailer the two side floor-panels 40, 42 can be rotated about hinge-pins 49a, 49b in the direction of arrow C from a substantially horizontal position as shown in FIG. 16 to a substantially or an approximately vertical position as shown in FIGS. 17 to 19 in a manner similar to the previously described embodiment. The trailer in this embodiment is convertible between the two configurations in the same manner as the trailer of FIGS. 1 to 11 and the trailer of FIGS. 12 to 15 are convertible between the two configurations. When the two side floor-panels are in the upward-folded position as shown in FIG. 17 and FIG. 18 they are supported by an appropriate stop or locking mechanism such as a device incorporated into the hinge fittings or a removable support arm located in an appropriate position or by being restrained by the sides of centre floor-panel 47 into a position as shown in FIG. 17.

In another embodiment, side floor panels 40, 42 can be folded down in the direction of arrow D as shown in FIG. 19 rather than being folded up as shown in FIGS. 17 and 18. In another embodiment, the side floor panels 40, 42 can be folded up then folded down or in other embodiments the side panels 40, 42 can be folded down, then folded up. Usually, the side floor panels 40, 42 will finish the folding operation in a generally upwardly extending direction.

In this configuration the trailer can be placed on a suitable support stand 50 or similar attached to the front end (not shown) and the rear end (shown in the figures) of the central floor-panel 47 as shown in FIGS. 17 to 19. Support stand 50 can be a separate device able to be releasably attached to the central floor-panel 47 by means of clamping or bolting or inserting or using other appropriate means of convenient attachment and detachment incorporated into the structure of stand 50 and/or the rear end of central floor-panel 47. Alternative to being a separate device, a support stand 50 can be incorporated into the construction of the trailer by utilizing extendable and retractable structures or by folding and unfolding fittings of appropriate length and positioning attached accordingly to the ends or underside of the trailer floor. One example includes the stand being hingedly connected to the trailer, particularly one or both ends of the trailer.

A similar support stand 50 to the support stand 50 at the rear of the trailer can be similarly attached to or incorporated into the front end of central floor-panel 47 or can be substituted by the use of a conventional front support wheel assembly known generally as a jockey wheel attached to the front end of central floor-panel 47 or to the drawbar 4 to assist the trailer to be maneuvered in any direction either as it is being converted to the in-use configuration or when in the in-use configuration.

The support stands or alternative arrangements can be fitted with multi-directional wheels or castors 51 located at the end of the stand in contact with the floor so that the trailer, when supported and elevated between support structures at the each end, may be maneuvered from a location employed for folding and unfolding to a different location for convenient storage. In these embodiments, the trailer can rest on the stand or stands only or on a combination of the road wheels 20 and stand or stands 50.

When the two side floor-panels 40, 42 are in the upward-folded position as shown in FIG. 17 and FIG. 18 cross-member 6 is disengaged from the positioning and locking mechanisms incorporated into the two side floor-panels to maintain cross-member 6 in the position perpendicular to the drawbar when the trailer is in the in-use configuration, i.e. pins 9a can be removed and/or released.

With the support stands or alternatives in appropriate positions and subsequently applying the required stability to the trailer, cross-member 6 is now able to be pivotally rotated in a horizontal plane about pivoting fastener 7 to a position substantially aligned longitudinally with drawbar 4 as shown in FIGS. 18 and 19. Side floor-panels 40, 42 are now able to be rotated about hinge-pins 49a, 49b in a downward direction in the direction of arrow D to a substantially downwardly depending vertical position as shown in FIG. 19 or to an approximately downwardly inclined vertical position if pivotal movement is restricted by road wheel 20 depending on the exact position adopted by road wheel 20.

Other embodiments of the present invention relate to the suspension system use on the trailers.

The embodiment illustrated in FIG. 21 shows the use of one form of the suspension system which is a rubber torsion suspension system in which a rubber torsion suspension block 55 or similar, is provided interconnecting axle 18 to hanger 14 or bracket which is downwardly depending from plate 12 in the form of a substantially L-shaped bracket. The rubber block suspension unit 55 provides for relative movement of wheel 20 with respect to hanger 14, particularly upwards and downwards movement.

In FIGS. 22a and 22b there is shown a still further embodiment of the suspension system useful in the present invention. The embodiment shown in FIGS. 22 involves the use of a coil-spring/shock-absorber unit provided on either side of road wheel 20 to form a pair of suspension units.

In this embodiment the complete wheel assembly includes mounting plate 12 pivotally attached to the underside of transverse member 6 about pivot fastener 13. Fixedly attached to mounting plate 12 is a pair of wheel suspension assembly frames 57 arranged in a triangular configuration, as shown in FIG. 22b and, pivotally, a pair of coil spring/shock absorber units 56. Pivoting connecting plates 58 are pivotally connected to the distal ends of each wheel suspension assembly frame 57, and to the end of each axle 18. At a point between these two connections, each coil spring/shock absorber unit 56 is pivotally attached to connecting plate 58. The position of the attachment point is determined by the requirement of the coil spring/shock absorber 56 to provide adequate suspension for its share of supporting the weight of the trailer and its load, as applied by the lever action of the pivoting connecting plate 58. Hence, by design this facility can be used to adjust the tension and the stiffness or “profile” of the suspension according to market requirements. With this design format, each road wheel 20 is free to move up and down in an arc around the point of attachment to each wheel suspension assembly frame 57. Plate 58 provides the movable connection between fixed frame 57 and movable units 56.

In the embodiment of FIG. 23a and FIG. 23b, a pair of coil spring/shock-absorber units 56 are located intermediate the undersurface of transverse cross member 6 at either side of axle 18 for carrying road wheel 20 when journalled on axle 18. In this embodiment road wheel 20 is free to move upwards and downwards in accordance with corresponding movement of the pair of coil springs or shock absorber units 56.

In a still further embodiment of the present invention the wheel assembly is non-pivoting but remains at a constant orientation to the transverse member so that when the transverse member is aligned along the longitudinal length of the drawbar the plane of the wheel is substantially perpendicular to the longitudinal axis of the drawbar such as depicted in FIGS. 9, 14 and 18.

A further embodiment is shown in FIG. 24. In the embodiment of FIG. 24, a half-elliptic leaf spring 59 is fixedly transversely mounted at or about its mid point to the underside of cross-member 6 by a suitable connector or similar and pivotally connected at either end to pivoting swing arms 60 to which are affixed axles 18 for carrying road wheels 20. In this embodiment road wheel 20 is free to move upwards and downwards in accordance with corresponding movement of the pivoting swing arms 60 which movement in turn is modulated by the leaf spring. When the cross member 6 and the leaf spring 59 is rotated as a single unit in a horizontal plane around pivoting fastener 7 to align with the drawbar, the wheels 20 remain in a substantially perpendicular plane to the longitudinal axis of the trailer. In this embodiment, the road wheels can pivot about to axles 18 or along with the wheel assemblies 8, 10 can pivot about cross-member 6 or the wheels are prevented from pivoting about axle 18 or with respect to cross-member 6 whilst still being able to rotate.

Advantages of the present invention include that the trailer, when in a stored configuration, occupies a minimum of space in a workshop, garage or similar, which space is only more or less about the width of a single road wheel or the diameter of a road wheel depending upon the particular embodiment and the particular suspension system used with the trailer. The length of the trailer in some embodiments is not increased when in the stored position but in other embodiments, such as for example, when fitted with stands, can be increased in length when in the storage configuration. The trailer may be quickly and easily converted between the in-use towing position and the stored position by a single operator without having to unnecessarily lift the trailer, since the trailer remains, in some embodiments, supported by its road wheels at all times, in all positions and at all stages in the conversion whilst in other embodiments the trailer may be supported and/or stabilised by supports such as a jockey wheel, stands, outriggers or the like.

When stored in the configuration as depicted in FIG. 19, the combined effect of the side floor-panels being folded down and the use of support stands 50 to provide a greater degree of stability enable safe and secure storage to avoid accidental damage or personal injury caused by the trailer becoming imbalanced and falling. In addition, as the stands provide for the trailer to be elevated so that the road wheels are clear of the ground, with the stands fitted with multi-directional wheels or castors the trailer can be moved longitudinally as well as laterally, enabling it to be moved along narrow paths and through narrow openings such as doorways and gateways.

The trailer is a full size trailer with standard weight carrying capacity.

The described arrangement has been advanced by explanation and many modifications may be made without departing from the spirit and scope of the invention which includes every novel feature and novel combination of features herein disclosed.

Those skilled in the art will appreciate that the invention described herein is susceptible to variations and modifications other than those specifically described. It is understood that the invention includes all such variations and modifications which fall within the spirit and scope.

1. A load carrying device convertible between an in-use configuration capable of carrying a load and a storage configuration, said load carrying device when in the storage configuration having a reduced size in at least one dimension when compared to the size in the in-use configuration, characterised in that there is a first member and a second member in which the first and second members are pivotal with respect to each other and arranged so that when the load carrying device is in the in-use configuration, the two members are transversely arranged to each other and when the load carrying device is in the storage position, the two members are substantially aligned with each other to extend in a common direction.

2. A load carrying device convertible between a first configuration and a second configuration which is a storage configuration characterised in that the load carrying device, when in the storage configuration, occupies a reduced amount of space when compared to the space required for the in-use configuration and in that the load carrying device comprises support elements for supporting the load carrying device, said support elements being located in different orientations with respect to each other depending on whether the load carrying device is in the in-use configuration or in the storage configuration.

3. A load carrying device according to any preceding claim characterised in that the first member is a main support member arranged to extend longitudinally along the lengthwise extending axis of the load carrying device.

4. A load carrying device according to any preceding claim characterised in that the first member is a drawbar.

5. A load carrying device according to any preceding claim characterised in that the second member is pivotally connected to the main support member for pivotal movement thereto such that the second support member adopts a substantially perpendicular arrangement with respect to the main support member when the load carrying device is in the in-use configuration and adopts a substantially parallel orientation with respect to the main member when the load carrying device is in the storage configuration.

6. A load carrying device according to any preceding claim characterised in that the second member is a movable crossbar or cross-member.

7. A load carrying device according to any preceding claim characterised in that the device is a trailer, caravan, or other wheeled vehicle adapted for towing.

8. A load carrying device according to any preceding claim characterised in that the load carrying device is a two wheeled domestic trailer.

9. A load carrying device according to any preceding claim characterised in that there is a load supporting structure supported by the first and second members when the load carrying device is in the in-use configuration.

10. A load carrying device according to any preceding claim characterised in that the load supporting structure includes at least one foldable panel, preferably two or more foldable floor panels which are foldable to assist in conversion of the load carrying device from one configuration to another configuration.

11. A load carrying device according to any preceding claim characterised in that the load carrying device is provided with one or more sides and/or one or more ends in which the sides or ends are foldable or removable.

12. A load carrying device according to any preceding claim characterised in that the sides and/or ends are in the form of panels which are releasably secured to the trailer or hinged to the trailer.

13. A load carrying device according to any preceding claim characterised in that the load carrying device is provided with one or more wheel assemblies movably mounted to the trailer, preferably to the cross-member allowing pivotal movement of the wheel assembly.

14. A load carrying device according to any preceding claim characterised in that the pivotal wheel assemblies include at least one road wheel arranged so that when the load carrying device is in the in-use configuration, the road wheel is substantially arranged to rotate in a plane substantially perpendicular to the cross-member whereas when the load carrying device is in the storage configuration, the road wheel is arranged to lie in the lengthwise extending plane or the cross-member.

15. A load carrying device according to any preceding claim characterised in that the least one dimension which is reduced in size when the load carrying device is in the storage configuration is the width of the trailer.

16. A load carrying device according to any preceding claim characterised in that the width of the load carrying device in the storage configuration is generally greater than or about equal to or less than about the width of the road wheel or generally about the diameter of the road wheel including the tyre mounted on the rim forming the road wheel, preferably, less than or about equal to about 500 mm.

17. A load carrying device according to any preceding claim characterised in that the load carrying device further includes a stand for assisting stability of the trailer when the trailer is in the storage configuration or when being converted to and from the storage configuration.

18. A load carrying device according to any preceding claim characterised in that the load carrying device includes one, two or more individual stability stands arranged to extend from the front and/or rear of the load carrying device.

19. A load carrying device according to any preceding claim characterised in that the load carrying device is a trailer, caravan, or other wheeled vehicle.

20. A load carrying device according to any preceding claim characterised in that the floor panel and side panel located on one side of the device is foldable in unison.

21. A load carrying device according to any preceding claim characterised in that the load carrying device further includes a suspension for supporting the wheel onto the device allowing relative movement of the wheel with respect to the device.

22. A load carrying device substantially as hereinbefore described with reference to the accompanying drawings.
